(19) United States
(12) Patent Application Publication
(10) Pub. No.: US 2009/0219192 A1
(43) Pub. Date: Sep. 3, 2009

(54) MOISTURE DISCHARGING RADAR ANTENNA FOR LIQUID LEVEL DETECTION

(76) Inventor: Hendrikus Algra, Waalre (NL)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/092,267

(22) PCT Filed: Oct. 26, 2006
(86) PCT No.: PCT/NL2006/000540

§ 371 Date: Aug. 13, 2008

(30) Foreign Application Priority Data
Oct. 31, 2005 (NL) 1030317

(51) Int. Cl. G01S 13/08

(52) U.S. Cl. 342/124

(57) ABSTRACT

The invention relates to a device for determining the level of a liquid, at least comprising a radar antenna disposed above the liquid for emitting radar waves to the liquid and receiving radar waves reflected by the surface of the liquid, as well as means for determining the liquid level on the basis of the emitted and reflected radar waves, wherein the radar antenna has an emitting surface which is directed downwards at the liquid and which is horizontally oriented with respect to the surface of the liquid, which emitting surface is provided with means that promote the discharge of condensation that is present on the emitting surface.

Device for determining the level of a liquid by means of a radar antenna, as well as such a radar antenna.

### DESCRIPTION

The invention relates to a device for determining the level of a liquid, at least comprising a radar antenna disposed above the liquid for emitting radar waves to the liquid and receiving radar waves reflected by the surface of the liquid, as well as means for determining the liquid level on the basis of the emitted and reflected radar waves, wherein the radar antenna has an emitting surface which is directed downwards at the liquid and which is horizontally oriented with respect to the surface of the liquid.

The invention also relates to a radar antenna for use in such a device.

Radar (Radio Detection And Ranging) is widely used for contactless distance determination. A very well-known principle that is used in this connection is the time difference method. According to this method, a radar antenna emits a radar signal that falls on an object, for example a liquid surface. The object reflects part of the emitted radar signal/wave back in the direction of the radar antenna, which receives the reflected radar signal/wave.

Although it is possible to use separate radar antennas for the emitted radar signal and for the reflected radar signal, it is usual to use one and the same radar antenna both for emission and for reception. The radar system measures the time difference Δt between the emitted radar signal and the received radar signal. Since the speed of the radar signal is known, it is easy to determine the distance relative to the surface of the liquid.

A device as described in the introductory paragraph, which employs the above measuring principle, is frequently used for precise determination of the level of a liquid, for example water or oil in a storage tank in the process industry or in an oil refinery, by means of radar signals. To that end a radar antenna provided with an emitting surface, which is directed downwards and which is furthermore horizontally oriented with respect to the surface of the liquid is disposed at the top of the tank.

A drawback of the radar systems that are currently known is the fact that the horizontally oriented emitting surface of the radar antenna is very sensitive to condensation of moisture in the storage tank. The condensation that has formed, which adheres to the emitting surface, interferes with the distance measurement, since the condensation interferes with the transmission of radar signals by the emitting surface.

The object of the invention is to overcome the aforesaid drawback and to provide a device as referred to in the introductory paragraph by means of which the liquid level in a tank can be determined more precisely without the adverse influences as described above.

According to the invention, the device is to that end characterised in that the emitting surface, which is horizontally oriented with respect to the surface of the liquid, is provided with means that promote the discharge of condensation that is present on the emitting surface.

Because condensation can no longer permanently adhere to the horizontally oriented emitting surface but, on the contrary, is more actively discharged, it does not affect or interfere with the transmission of the radar waves by the emitting surface, which has a positive effect on the precision of the level measurement carried out in the storage tank.

In a more functional embodiment of the invention, said means comprise at least one element projecting from the emitting surface in the direction of the liquid surface.

Said at least one element may have a tapered end.

In a specific embodiment, said at least one element is conical or pyramidal in shape.

An adequate discharge of condensation is obtained in that according to the invention the surface of said at least one element includes an angle α of at least 45° with the emitting surface.

It is noted that International patent application WO 03/048697 discloses a device for determining the level of a liquid in a tank, wherein the radar antenna or the emitting surface is disposed at an angle with respect to the liquid surface in the tank. As a result of the sloping position of the radar antenna, any condensation that may have formed can be discharged under the influence of the force of gravity.

An important drawback of the sloping position of the radar antenna or the emitting surface, however, is the fact that the emitted radar signal is not perpendicularly incident on the liquid surface, but at an angle, which leads to disturbances in the reflected radar signal, among which scattering and reflections from the tank walls. Said reflections seriously affect the precision of the level measurement, which imprecision can only be remedied by taking additional, usually complex and costly correction measures.

The invention will now be explained in more detail with reference to a drawing, in which:

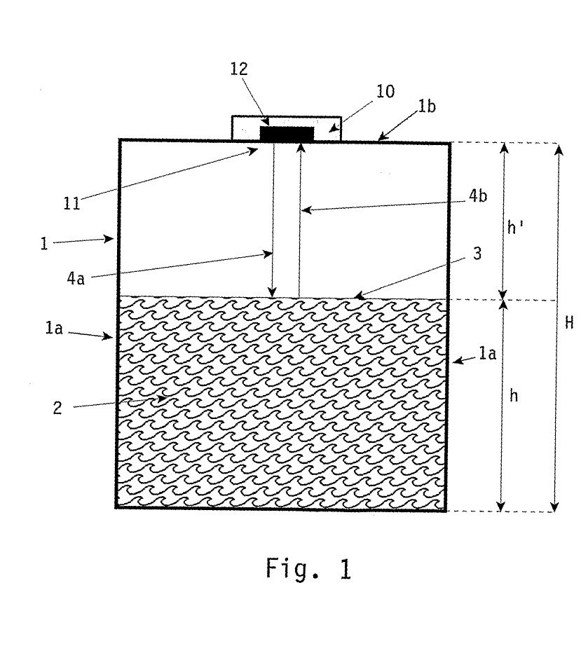

FIG. 1 shows a device according to the prior art;

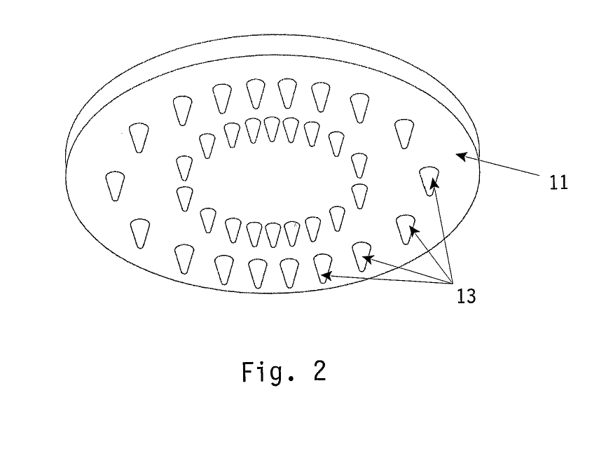

FIG. 2 is a detail view of a first embodiment of the invention; and

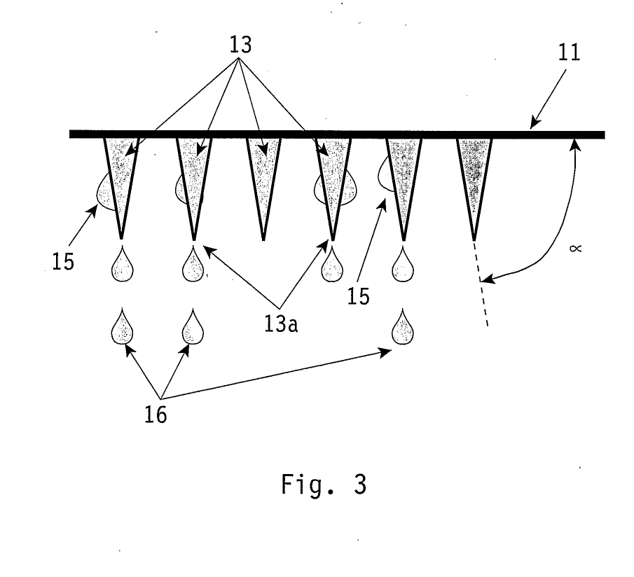

FIG. 3 is another detail view of an embodiment according to the invention.

For a better understanding of the invention, like parts will be indicated by the same numerals in the description of the figures below.

FIG. 1 schematically shows a prior art device for determining the level of the liquid in a tank. The device 10 is disposed at the top of a tank 1, which is built up of walls 1a and a roof 1b. The height of the tank 1 is indicated by the letter H.

Present in the tank 1 is an amount of liquid 2, the height of the liquid level 3 of which is indicated by the letter h.

The prior art device 10 comprises at least one radar antenna 12 provided with an emitting surface 11 for emitting a radar signal 4a in the direction of the liquid surface 3. The radar signal 4a is partially reflected by the liquid surface 3, and the reflected radar signal 4b is in turn received by the radar antenna 12.

The prior art device 10 is furthermore provided with means for determining the liquid level 3 (h) on the basis of the emitted radar signal 4a and the reflected radar signal 4b, wherein the measuring system is based on the following equations (1) and (2):

h′=H−h=1/2·c·Δt_{4a+4b} (1)

or

h=H−1/2·c·Δt₄ₐ₊₄ (2)

wherein
H the height of the tank [m]
h′ =the distance between the radar antenne and the liquid surface [m]
h=the height of the liquid level [m]
c=the propagation rate of the radar waves [m/sec]
Δt₄ₐ₊_{4b}=the time difference between the emitted radar signal and the reflected radar signal [sec]

In this way it is possible to determine the exact height of the level of the liquid 2 in the tank 1.

The measurement by the device 10 is adversely affected, however, by condensation which forms on the emitting surface 11 or the radar antenna 12 and which adversely affects the transmission of the radar signals, and consequently also renders the measurement for determining the level imprecise.

FIGS. 2 and 3 show an embodiment of a radar antenna or emitting surface, which is according to the invention provided with means that promote the discharge of condensation. In FIG. 2, the emitting surface 11 is provided with elements having a tapered end 13a, which are directed towards the liquid surface 3.

More particularly, the elements 13 are conical or pyramidal in shape and are arranged in groups on the emitting surface 11 of the radar antenna 12.

As the figures show, the elements 13 are arranged in at least one circumferential pattern, for example a circular pattern, on the emitting surface 11. The elements 13 may also be arranged in several concentrical circumferential platforms. Other patterns may be functional as well, as long as they do not affect the effectiveness of the radar antenna adversely, i.e. do not interfere with the emitted and received radar signals 4a-4b. As is clearly shown in FIG. 2, the elements 13 only take up a small part of the area of the emitting surface 11, so that they do not interfere with the radiation characteristics of the radar and in particular with the emitted and received radar signals 4a-4b. Preferably, the elements 13 are made of a material that is transparent to the radar signals.

As a result of the conical shape of the elements 13, the condensation 15 that has formed on the elements 13 can be easily discharged in the form of droplets 16 under the influence of the force of gravity. In this way the elements 13 promote the discharge of condensation, so that the condensation 15 will not accumulate or collect on the emitting surface 11 or the radar antenna 12 and thus will not adversely affect or interfere with the level measurement.

As is shown in FIG. 3, the surface of each element 13 includes an angle α with the emitting surface 11, which angle is at least 45°.

It will be understood that in addition to being used for level measurement in a storage tank, the device according to the invention may also be used in carrying out level measurements on other liquids, such as the cooling-water level of a nuclear reactor or the level of open water (lakes, seas, etc).

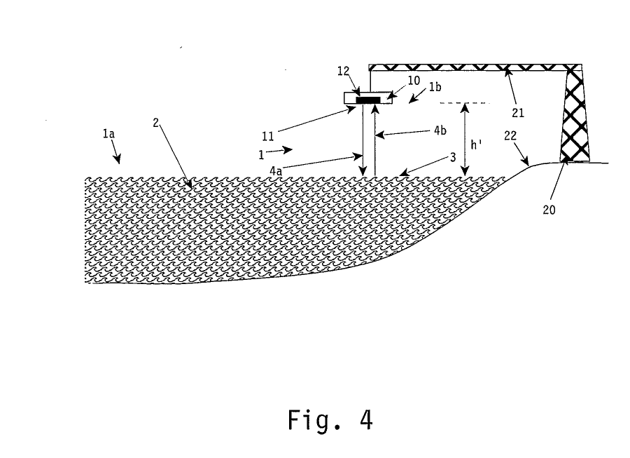

An embodiment intended for use in the latter measuring method is shown in FIG. 4. FIG. 4 shows an open water or 1a, which may be a lake, for example, or a river or a sea. To enable a precise measurement of the liquid level 3, the device is installed on the bank/shore 22 and is built up of a housing or frame 20 having an arm 21 that projects above the water level 3. Mounted on the arm 21 is the device 10 according to the invention for precisely measuring the height h′ of the water level 3.

In this way it is possible to measure in particular the wash of the water 2 in an adequate manner, for example for coast protection purposes.

1. A device for determining a level of a liquid, comprising:
a radar antenna configured to emit radar waves to the liquid and to receive radar waves reflected by the liquid; and
a measuring system configured to determine the level of the liquid based on the emitted and reflected radar waves;
wherein the radar antenna comprises an emitting surface having multiple elements that project from the emitting surface and that promote discharge of condensation present on the emitting surface.

2. The device according to claim 1, wherein the elements are spaced apart on the emitting surface.

3. The device according to claim 2, wherein the elements are arranged in at least one circumferential pattern on the emitting surface.

4. The device according to claim 3, wherein the elements are arranged in multiple circumferential patterns on the emitting surface.

5. The device according to claim 1, wherein each of the elements has a tapered end.

6. The device according to claim 1, wherein the elements are conical in shape.

7. The device according to claim 1, wherein a surface of at least one of the elements forms an angle α of at least 45° with the emitting surface.

8. A radar antenna comprising an emitting surface configured to emit radiation, the emitting surface comprising multiple elements that project from the emitting surface and that promote discharge of condensation present on the emitting surface.

9. The radar antenna of claim 8, wherein the elements are arranged in at least one circumferential pattern on the emitting surface.

10. The radar antenna of claim 8, wherein the elements are arranged in multiple circumferential patterns on the emitting surface.

11. The radar antenna of claim 8, wherein the elements are conical in shape.
